(19) United States
(12) Patent Application Publication
(10) Pub. No.: US 2012/0223152 A1
(43) Pub. Date: Sep. 6, 2012

(54) Method for dispensing liquid live release formula into boat livewell

(76) Inventor: Rodney Blake Hairgrove, Gilbertsville, KY (US)

(21) Appl. No.: 12/932,578

(22) Filed: Mar. 1, 2011

(51) Int. Cl. B05B 1/00

(52) U.S. Cl. 239/1

(57) ABSTRACT

Abstract: A method for dispensing a liquid live release formula from a pre-filled tank and pump “(8)” directly into an internal livewell “(7)” of a bass boat “(1)”, for simplifying fish care for the purpose of prolonging the life of captive fish being transported. This method involves the tank and pump “(8)” having a vertical mounting bracket “(16)” connected thereto; whereby the bracket “(16)” can be connected to a vertical surface on the bass boat “(1)”. The tank and pump “(8)” is pre-filled with the liquid live release formula prior to launching into a body of water via a refill cap “(17)” located on the top of the tank and pump “(8)”. The liquid live release formula is dispensed into the internal livewell “(7)” of the bass boat “(1)” via a spray nozzle “(9)” installed through the livewell “(7)” connected to the tank and pump “(8)” via a poly sprayer hose “(10)” intersected by an anti feedback valve “(11)”. The anti feedback valve “(11)” prohibits liquid live release formula and water from backflowing into the tank and pump “(8)”. This method is energized by the boat's main accessory battery “(12)” controlled via a waterproof, momentary power button “(15)” located on/near a control console “(4)” and managed by the operator of the bass boat “(1)”.

### BACKGROUND—PRIOR ART

The following is a tabulation of some prior art that presently appears relevant:

### U.S. Patents Patent Number Kind Code Issue Date Patentee

U.S. Pat. No. 7,836,851 B2 2010Nov. 11-23 Gergely, et al.
U.S. Pat. No. 6,598,806 B2 2003Jul. 29 Phipps
U.S. Pat. No. 4,905,904 B05B 1/10 1990Mar. 6 Ohara, et al.
U.S. Pat. No. 2,914,256 1959Nov. 24 O'Shei

### Nonpatent Literature Documents

Allen, T., & Southwick, R., “Sportfishing in America.” January 2008.
http://www.asafishing.org/images/statistics/resources/Sportfishing %20in %20America %2
0Rev. %207%2008.pdf (Jan. 11, 2011).

### BACKGROUND

According to the American Sportfishing Association, “Nearly 40 million anglers generate over $45 billion in retail sales with a $125 billion impact on the nation's economy creating employment for over one million people. Their dollars employ millions of people in industries ranging from fishing tackle to travel and hospitality to boat manufacturing” (Allen & Southwick, 2008, p. 2).

The sport and the economy that fishing creates would not be possible without fish. The only way to maintain suitable environments for the most viable commodity of the sport is to make sure that the environment is treated responsibly and protected.

In order to conserve the freshwater fish for generations to come, live release formula has been developed to try and help captive fish stored in livewells to survive the heat and stress of being caught and held until they can be weighed and released back into their natural environment. U.S. Pat. No. 7,836,851 to Gergely, et. al. discloses more details regarding live release formula and the method for treating water in fish tanks.

There are professional tournament anglers and amateurs alike that depend on the earnings from these animals and can face stiff penalties if their catch does not survive until the weigh in. Therefore they must spend time away from casting their rods by adding live release formula into their livewells regularly to help their catch survive. Just a few seconds of not wetting the line can mean the difference between thousands of dollars. In order to have the opportunity to continue fishing tournaments, it is also imperative that anglers take care of their captive fish so that the fish can be placed back into the fishing waters to be caught another day and to replenish the population.

Although live release formula has been proven to help maintain the life of captive fish, the formula is often messy. The formula often creates a mess in the boat and has created difficulties for anglers' in finding ways to store the formula. If the formula gets moisture in it, it can create clumps and make it harder to measure and dispense into the livewell. Therefore it was determined that there was a need to assist anglers attempting to be environmental stewards by making a process more automatic to deliver the fish formula into their boat livewells without penalizing them by taking away much needed fishing time or creating a mess in their equipment.

Upon investigating bass boats and equipment used by anglers, it was determined that by using some sort of container to hold the fish release formula in liquid form and placing a hose and pump into the workings of the boat, the angler could press a button and the liquid fish formula could automatically be released into the boat livewell without any measuring or time wasted. This button could be pressed while the angler is running down a body of water to his next fishing spot or as he is tying on bait and/or lures.

The automobile has a similar system set up for windshield washer fluid to be dispensed onto the windshield of a car. The windshield washer fluid is used to help clean the windshield so that the driver can better see in front of him. A liquid chemical is released by the driver with a pull of a lever and dispensed onto the windshield by a spray nozzle. So the automobile system made up of a reservoir, hose, lever, spray nozzle and pump were all investigated to see if it would be possible to use it in a bass boat to fill the need of the environmental steward and assist in making it easier for anglers to maintain the most viable commodity of the sport of fishing.

### SUMMARY

The present embodiment relates to a method for dispensing a liquid live release formula into the internal livewell of a boat for the purpose of prolonging the life of captive fish being transported using two patented products together for a new use to solve a recognized problem for anglers.

In bass fishing tournaments and other fishing tournaments it is a common requirement that the fish caught must be maintained in a live condition and released back into a lake or other body of water at the end of the tournament. Because of this and also to permit fish to be caught and kept alive in good physical condition for extended periods, most bass boats are equipped with one or more holding tanks which are often referred to as livewell tanks for live bait and which can be also used to keep fish which have been caught alive. Such tanks are customarily fitted with a pump so as to supply aerated fresh or salt water so as to continuously replace the water in the tank. The pump's intake is below the water line and its discharge is into the tank. The water level in the tank is controlled generally by a drain tube which discharges overboard. The aerated water is important so as to keep the bait fresh and active and is absolutely vital for tournament fishing contests wherein the catch is kept alive and reasonably healthy after which it is weighed and then released back into the body of water from which it was taken.

It has also been proven by U.S. Pat. No. 7,836,851 that a fish handler can properly condition the water to increase his ability to maintain the lives of fish held in captivity in a water tank by using a live release formula and method for treating water in livewells. This patented formula sedates the live fish causing them to fight less which allows them to require less oxygen and provoke less harm to other captive fish around them. This also allows larger amounts of fish to be carried in less volumes of water. Using this patented formula also properly handles and contains the electrolyte losses of the fish due to the stress of being caught. If these ions are not maintained or replenished, the fish can go into osmotic shock. Other conditions that could create a loss of life for live fish in a water tank are minimized by this formula such as removing chlorine in the holding tank water, replenishing the natural anti-bacterial slime coating of the fish, protecting the fish from bacterial, fungal and viral loads, and reducing the amount of ammonia, a by-product of fish waste, that can render the fish gills unable to absorb oxygen.

Adding a live release formula to any water tank that is already properly aerated can significantly improve the chances of survival of the captive, live fish to be placed back in their fishery to breed and live another day. Many anglers use this formula currently; however there is an unresolved need for anglers in how to get this patented formula into their livewells without penalizing them by storage issues, time away from fishing, and messiness.

Windshield cleaning systems have been used on motor vehicles for some time. The general operation of such systems depend upon a cleaning fluid stored in a fluid reservoir, often under the hood of the car, being forced onto the windshield and wiped off by the windshield wipers. Thus by manually controlling the windshield wipers and cleaning spray, the operator of the vehicle may spray the cleaning fluid upon his windshield and immediately wipe it off by means of the sweeping windshield wipers thus cleaning dirt and grime from the windshield surface and improving his vision.

U.S. Pat. No. 2,914,256 to O′Shei relates to a windshield cleaning apparatus that discharges water or other liquid onto the windshield in the path of movement of the wiper blades in order to clean mud and dirt from the windshield. The cleaning liquid is stored in a container from which it may be discharged through the nozzle by a pump, plunger or the like. This apparatus also discusses having two separate liquid containers and two pumps. While for our function we would be using only one container filled with liquid and only one pump and we would not require any movement from any other parts to fulfill the function of the embodiment. We would be instilling liquid live release formula to maintain the lives of captive fish in a livewell instead of cleaning anything but we would be using a container to hold liquid live release formula and a pump to successfully administer the liquid formula into a boat livewell instead of onto a motor vehicle windshield.

U.S. Pat. No. 6,598,806 to Phipps does discuss using the windshield washer apparatus containing the tank and pump in a marine craft; however once again the patent only discusses using the apparatus for the same manner as it is used on a motor vehicle. The patent just imposes using the windshield washer tank for the purpose of cleaning the windshield(s) in a marine craft.

Our embodiment suggests a new use for the patented windshield cleaning system encompassing a container for which liquid live release formula held in a tank may be discharged through a spray nozzle by a pump into the livewell of the boat using a waterproof, momentary power button installed on/near the control console of a bass boat. This invention would fulfill the unsolved need of anglers on how to administer this patented live release formula into the internal livewell to promote fish care and environmental stewardship.

Accordingly several advantages of one or more aspects of this embodiment are as follows: extremely helpful to the angler by helping them not waste any fishing time, it would be helpful to the conservation of fish themselves because it will be more likely for the additive to be used in the correct amount and more regularly helping them to survive, it will also help our fisheries to maintain the fragile eco balance, ensure future professional and amateur anglers that they will have critters to chase in the years to come to still be able to earn money in this sport, and enable families the opportunity to continue to have this option as a recreational sport and bonding time. This embodiment will also help minimize the frustrations of anglers using live release formula by helping eliminate mess in their equipment and clumps in the powder formula which make it hard to measure and dispense.

Other objects and features of the invention will become more apparent from the following detailed description with reference to the accompanying drawings.

### DESCRIPTION OF THE DRAWINGS

In the accompanying drawings which form a part of the specification and are to be read in conjunction therewith and in which like reference numerals are used to indicate like parts in the various views:

FIG. 1 is a diagrammatic view of a fishing boat which is equipped with a livewell and with a control console to illustrate position and installation of the preferred embodiment of the present invention;

FIG. 2 is a detailed view of the components of the preferred embodiment and how they interconnect with the parts of a fishing boat livewell;

FIG. 3 is a view of the control console in a fishing boat from FIG. 1 on an enlarged scale with the component parts of the preferred embodiment illustrated.

Drawings - Reference Numerals

| | |
|---|---|
| 1 | fishing boat |
| 2 | hull |
| 3 | stern |
| 4 | control console |
| 5 | control panel |
| 6 | steering wheel |
| 7 | livewell |
| 8 | tank and pump |
| 9 | spray nozzle |
| 10 | poly sprayer hose |
| 11 | anti-feedback valve |
| 12 | main accessory battery |
| 13 | ground wire |
| 14 | 12 volt control wire to pump |
| 15 | waterproof, momentary |
| | power button |
| 16 | mounting bracket |
| 17 | refill cap |
| 18 | 12 volt control wire from |
| | power supply |

### DETAILED DESCRIPTION

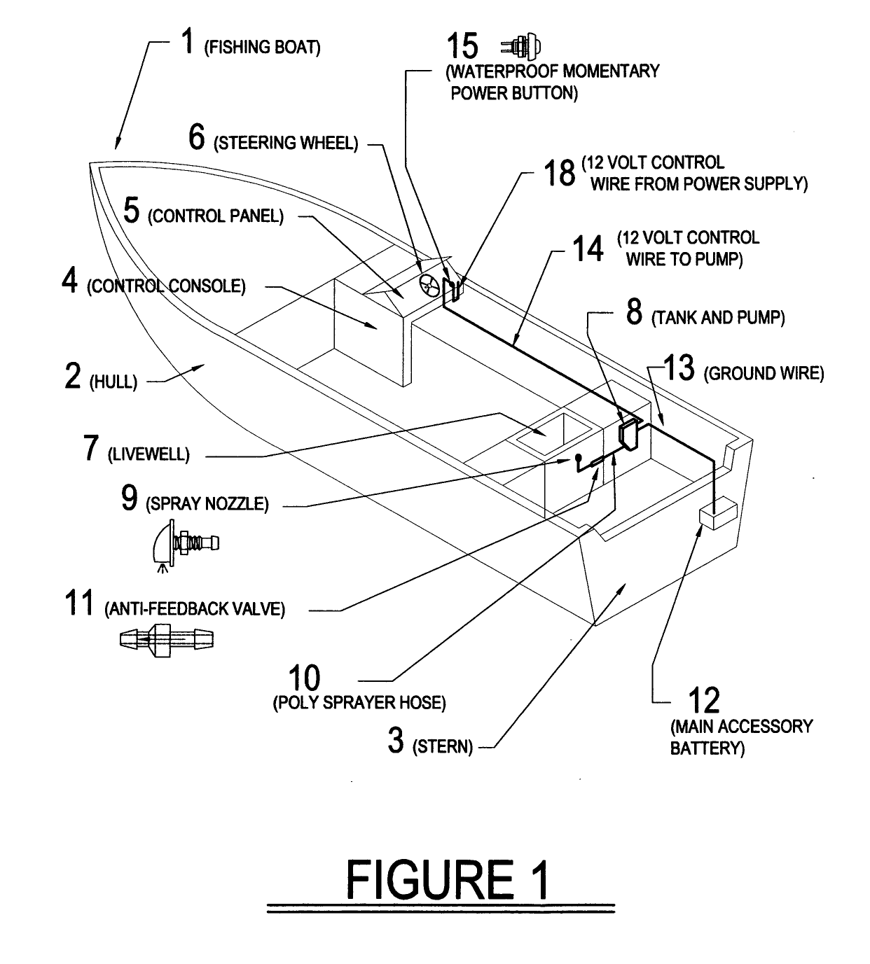

Referring now to the drawings in more detail and initially to FIG. 1, numeral 1 generally designates a bass boat or other fishing boat having a hull 2 and a stern 3. A control console 4 is provided near the center of the boat 1. The console 4 has a control panel 5 on which a steering wheel 6 and other controls are mounted. The operator of the boat normally occupies an operator's station immediately behind the console 4.

In accordance with the present embodiment, the livewell 7 is mounted in the boat 1 to hold the fish that are caught. The livewell 7 may be situated at any specific location by the boat manufacturer but is typically located and is shown behind the operator's station at the control console 4 near the stern 3.

Numeral 8 generally identifies a tank and pump which is utilized in accordance with the present invention and which serves to control the flow of liquid live release formula from the tank 8 to the livewell 7. The livewell 7 is equipped with a spray nozzle 9 located in the back of the livewell 7 above the ordinary water level. A poly sprayer hose 10 is connected to the spray nozzle 9 and the tank and pump 8, dissected with an anti-feedback valve 11.

The tank and pump 8 are connected to a main accessory battery 12 by a ground wire 13. The tank and pump 8 also has a 12 volt control wire to pump 14 connected at the control panel 5 to a waterproof, momentary power button 15. The waterproof, momentary power button 15 is then connected to a 12 volt control wire from power supply 18.

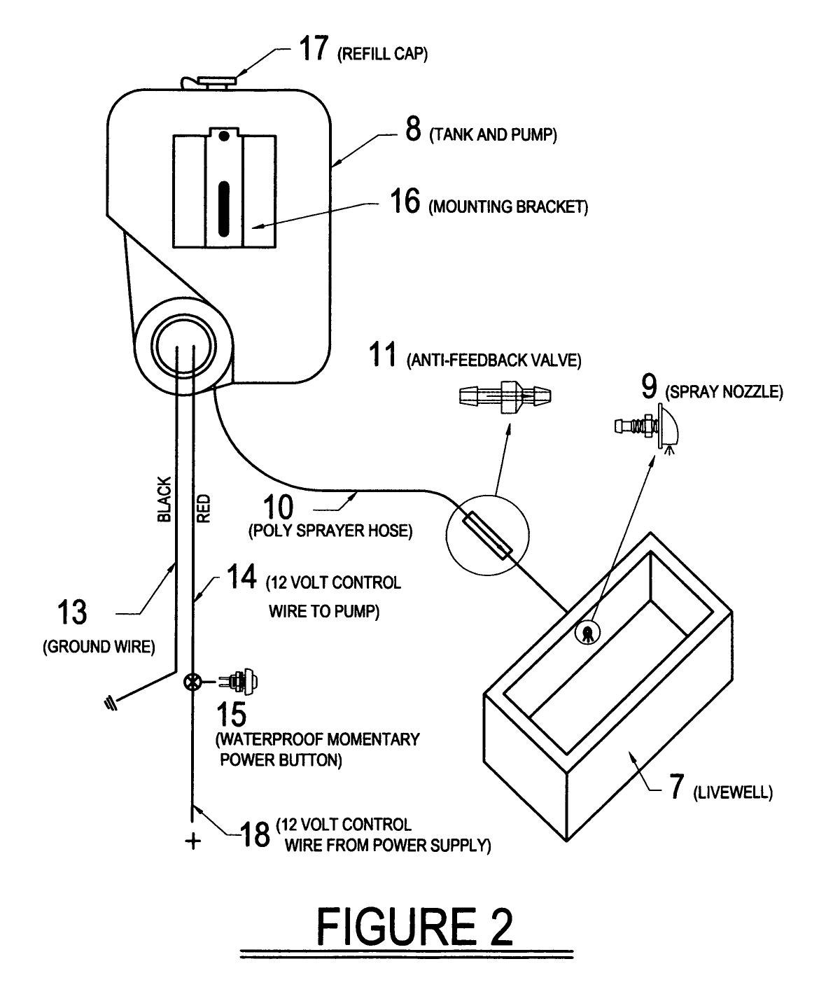

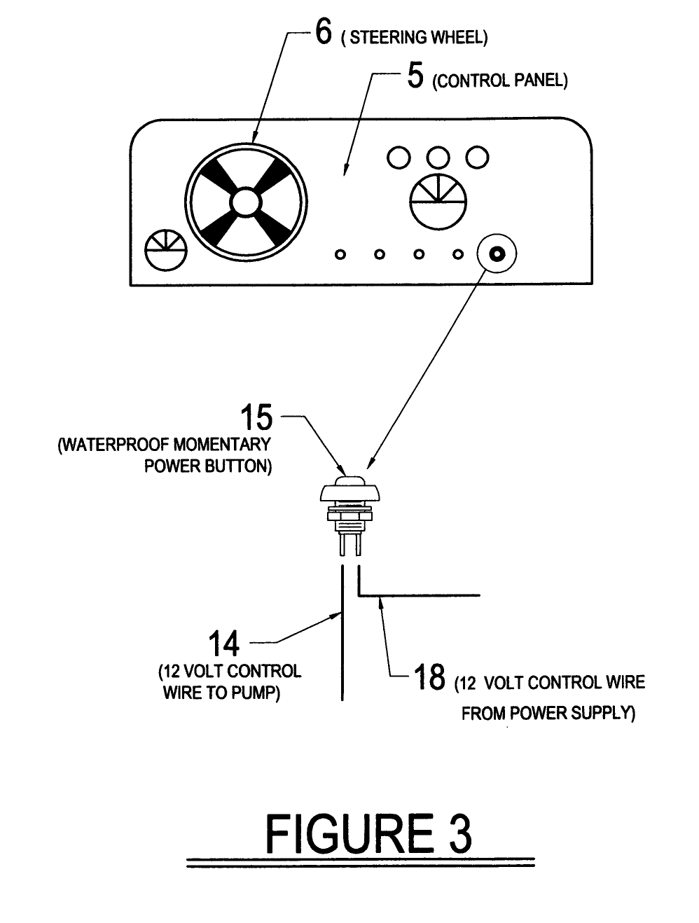

Referring now more particularly to FIG. 2, the tank and pump 8 has an insert for a mounting bracket 16 and a refill cap 17. In FIG. 3 the waterproof, momentary power button 15 is connected to the 12 volt control wire to pump 14 and the 12 volt control wire to power supply 18.

### Operation

FIG. 1 shows a diagrammatic view of a bass boat or other fishing boat having a hull 2 and stem 3. In the center of the boat 1, FIG. 1 shows the control console 4 equipped with the control panel 5, steering wheel 6 and the waterproof, momentary power button 15 powered by the main accessory battery 12.

The operator of the boat normally sits immediately behind the control console 4. When the operator of the boat presses the waterproof, momentary power button 15 it powers the 12 volt control wire from power supply 18 and then energizes the tank and pump 8 which are mounted in rear of boat 1 by the mounting bracket 16 and connected to the main accessory battery 12 via the ground wire 13. Prior to putting the boat 1 into a body of water, the tank and pump 8 is filled with liquid live release formula at refill cap 17. The tank and pump 8 are powered by the 12 volt control wire to pump 14.

Once the tank and pump 8 is energized, liquid live release formula is pumped from tank and pump 8 through the poly sprayer hose 10, past the anti-feedback valve 11, to the sprayer nozzle 9 located inside the livewell 7 dispersing liquid live release formula into the livewell 7. Liquid live release formula is sprayed for a period of three to five seconds or adequate amount of liquid live release formula to treat 20 to 30 gallons of water, depending on the size of the livewell 7.

This process can be repeated throughout the day to continually treat water in the livewell 7 in order to adequately maintain the optimal water condition to sustain captive fish. By having the live release formula already in the tank and pump 8 in a liquid form prior to usage, the operator of the boat will save time, effort and hassle of finding chemicals to treat livewell 7 and avoid undue hardship of measuring and dispensing clumped powder formula and possibly permanent staining of the boat 1. This embodiment will afford the operator of the boat 1 more time fishing and still allow them to be good stewards of the environment and fish care. The ease of using this embodiment could encourage more anglers to use live release formula which would enhance the chances of more fish maintained alive and in better condition to be released back into the body of water in which they came. This would in turn help to maintain the fragile eco balance of fisheries.

### CONCLUSION, RAMIFICATIONS, AND SCOPE

Accordingly, the reader will see that the embodiment will allow anglers to become better stewards of the environment by simplifying fish care for the purpose of prolonging the life of captive fish being transported. The ways that this embodiment can simplify fish care are:
live release formula will already be in liquid form prior to beginning the day on the water
less time is necessary to devote to fish care due to no measuring of live release formula, no handling of live release formula, no mess of mixing dry formula in the boat on the water, no concern of finding the compartment where the formula is stored on the boat, no clumping of powder live release formula
less time is wasted from actual fishing time to care for fish
the embodiment could possibly encourage more anglers to be better stewards of fish care due to the ease of operation
more anglers using live release formula could increase the number of fish being released back into the fisheries
more anglers using live release formula could improve the health of the captive fish released back into the fisheries

Although the description above contains many specificities, these should not be construed as limiting the scope of the embodiment but as merely providing illustrations of one embodiment. For example, the tank can have other shapes; the location of the tank and pump could be numerous; the waterproof, momentary power button can be different shapes or styles; the sprayer nozzle could operate in two livewells at the same time instead of just one as stated; the spray nozzle could be any different size, amount of holes present, etc.; the waterproof, momentary power button could be mounted in different locations; the embodiment could be utilized in other arenas of fish care besides a bass boat up to and including but not limited to holding tanks, transporting tanks, release boats, weigh-in holding tanks at fishing tournaments, etc.

Various modifications of the disclosed embodiment, as well as alternative embodiments will become apparent to persons skilled in the art upon the reference to the description of the invention. Thus the scope of the embodiment should be determined by the appended claims and their legal equivalents, rather than by the examples given.

I claim:

1. A method for dispensing a liquid live release formula from a pre-filled tank and pump directly into an internal livewell of a bass boat comprising;
a) said tank and pump having a vertical mounting bracket connected thereto, whereby said bracket can be connected to a vertical surface on said bass boat while said tank and pump remains level, and
b) a filler cap located on the top of said tank and pump for purpose of filling tank and pump with said liquid live release formula, and
c) poly sprayer hose connected to said tank and pump to transport said liquid live release formula to said livewell, and
d) an anti feedback valve as a means to control backflow from said livewell, and
e) a spray nozzle to dispense said liquid live release formula into said livewell, and
f) a waterproof, momentary power button to energize said tank and pump via a 12 volt control wire to pump, and
g) a 12 volt control wire to power supply from said waterproof, momentary power button, and
h) a ground wire from said tank and pump to a main accessory battery.
